(19) United States
(12) Patent Application Publication
(10) Pub. No.: US 2001/0013002 A1
(43) Pub. Date: Aug. 9, 2001

(54) Portable type voice reproducer and guide system using the reproducer

(75) Inventor: Yoshinobu Murai, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/779,269

(22) Filed: Feb. 8, 2001

(30) Foreign Application Priority Data
Feb. 9, 2000 (JP) 31334/2000

(51) Int. Cl. G10L 21/00

(52) U.S. Cl. 704/278

(57) ABSTRACT

Each of control signal transmitters (21-2n) is provided for each of a plurality of guide objects and transmits a control signal for discrimination of the corresponding guide object. A control signal detector (13) starts execution thereof by operation of a start button (12). A control signal detector receives the control signals, each of which is supplied from the control signal transmitters and detects one of the control signals, which has the maximum level for use of selection of one kind of the voice-data corresponding to the detected control signal transmitter. A controller (14) has received a message class such as a language class of Japanese or English for example from a class selector (19). The controller makes and sends out a selection signal with a detected control signal and a selected language class to a voice-data take-out circuit (15). The voice-data take-out circuit receives the control signal detected by the control signal detector and takes out a kind of the voice-data corresponding to the control signal from the voice-data storage (15). The voice-data storage has equipped a voice-data memory card (20), which is attachable and removable and has stored a plurality of kinds of the voice-data therein. A voice reproduction circuit (17) converts the voice-data received from the voice-data take-out circuit to an audible signal of the voiced message, reproduces the voiced message. And a voice output device such as a speaker (18), an earphone, or a headphone outputs the voiced message reproduced by the voice reproduction circuit.

### BACKGROUND OF THE INVENTION

The present invention relates to a portable type voice reproducer which selectively reproduces and outputs one of a plurality of voiced messages in accordance with a kind of voice-data for voiced messages, and a guide system which guides one of a plurality of guide objects by using the voice reproducer. Particularly, the present invention relates to the portable type voice reproducer which has simple facilities for processing the guide objects and which can be conveniently used by a user, and the guide system using the voice reproducer.

In recent years, at museums or exhibition halls, each visitor can individually listen to the explanation of the exhibits as given by the voice guide by using an earphone or a head phone of a rental portable type voice reproducer so as not to give other visitors any annoyances.

For example, in such the portable type voice reproducer as illustrated in FIG. 1, a voice-data memory card 120 which stores voice-data of a plurality of voiced guide messages each of which corresponds to the exhibition is equipped in a voice-data storage device 114 of the reproducer 110. As for an example, each of the exhibitions is given a number and a visitor pushes a number button arranged on a message selector 111 corresponding to the number given to the exhibits. In response a controller 112 detects the number code corresponding to the number buttons and instructs a voice-data take-out circuit 113 to take out the corresponding voice-data from the voice-data memory card 120 equipped in the voice-data storage 114.

The voice-data take-out circuit 113 sends the voice-data which is taken out from the voice-data storage 114 to a voice reproduction circuit 115 which converts the received voice-data and reproduces an audible signal corresponding to the voiced guide message. The audible signal is converted to the voiced guide message and is output from a voice output device such as a speaker 116, an earphone, or the like. The visitor can thus listen to the voiced guide message

In another example as illustrated in FIG. 2, each voice-data transmitter 221, 222, . . . , 22n is provided with voice guide data and are provided in each exhibit. Each of the voice-data transmitters 221, 222, . . . , 22N transmits voice-data by radio signals A, B, . . . , N, respectively.

In a portable type voice reproducer 210, a voice-data receiver 212 receives the radio signals A-N through an antenna 211 and selects the one at the maximum level to demodulate the selected signal. A voice reproducer 213 receives a demodulated one of the voice-data and converts the same into an audible signal. The audible signal is sent to a voice output device such as a speaker 214, an earphone, or the like. The visitor can listen to a voice guide message reproduced by, for example, the speaker 116.

However, the above-described portable type voice reproducer and the guide system have following problems.

In the portable type voice reproducer of which the description is given with reference to FIG. 1, the user will be annoyed by the troublesome operation because the user needs to repeatedly carry out the selecting operation to select the voice guide data for each of every exhibits to obtain the voice guide message.

In the guide system of which the description is given with reference to FIG. 2, each exhibited guide object requires the voice-data transmitter for transmitting the voiced guide message. Moreover, since the voice-data are always being transmitted from the transmitters, the reproduced voiced message might be undesirably started on a halfway of the message.

### SUMMARY OF THE INVENTION

It is therefore an object of the present Invention to provide a guide system with a portable type voice reproducer capable of obtaining both simplified facilities corresponding to guide objects and convenience regarding users thereof, and for resolving the above problems.

According to a first aspect of this invention, there is provided a portable type voice reproducer which reproduces and outputs a voiced message selected from a plurality of kinds of voice-data for voiced messages. The portable type voice reproducer comprises a detection means, a storage means, a take-out means, and a voice reproduction means. The detection means detects a signal received from outside corresponding to the voiced message. The storage means stores the voice-data. The take-out means takes out a specific voice-data from the voice-data storage corresponding to the signal detected by the detection means. The voice reproduction means converts the voice-data received from the take-out means to an audible signal of the voiced message, and reproducing and outputting the reproduced voiced message outside.

According to a second aspect of this invention, there is provided a portable type voice reproducer which comprises a control signal detector, a voice-data storage, a voice-data take-out circuit, a voice reproduction circuit, and a voice output device. The control signal detector receives and detects a control signal, which is received from outside and prepared for use of selection of one kind of the voice-data corresponding to each voiced message. The voice-data storage stores the voice-data. The voice-data take-out circuit receives the control signal detected by the control signal detector and takes out a kind of the voice-data corresponding to the control signal from the voice-data storage. The voice reproduction circuit converts the voice-data received from the voice-data take-out circuit to an audible signal of the voiced message, and reproducing the voiced message. And a voice output device outputs the voiced message reproduced by the voice reproduction circuit.

The control signals can be prearranged corresponding to each one of guide objects and may be different from each other. As a result, a different frequency only is enough for each control signal for example, and then, a transmitter of the control signal for the voice-data to be provided to each guide object is realized by a simple circuit.

Furthermore, as the kind of the voice-data stored in the voice-data storage corresponds to the control signal detected by the control signal detector, this portable type voice reproducer can read out the voice-data of one voiced message from the beginning. As a result, the user can listen to the voiced message corresponding to each guide object from the beginning by a simple operation.

It is preferable that the portable type voice reproducer further comprises a start button beginning execution of the detection means or the control signal detector. As a result, every time the operation of the start button executes by the user, the user can listen to the voiced message from the beginning.

It is preferable that the above-mentioned control signal is a radio signal of a faint power level, and said control signal detector receives the radio signal from outside thereof through an antenna. The above-mentioned control signal may be a light signal such as an infrared ray corresponding to each one of a plurality of the voice-data and the control signal detector may receives and detects the light signal from outside. As a result, any special structure or operation can be unnecessary for the receipt of the control signal.

It is preferable that the above-mentioned voice-data storage is equipping a voice-data memory medium, which is attachable and removable and has stored a plurality of voice-data therein. As a result, even if the exhibits in the exhibition hall are altered, their voice guide messages can corresponds to them only by preparing for and replacing the voice-data memory medium to may be a card and has stored guide-contents in accordance with exhibit-contents.

It is preferable that the portable type voice reproducer according to this invention further provides a class selector selecting one of message classes, which are included in each of the kinds of the voice-data corresponding to each of the voiced messages. As a result, in case that a voice guide has a plurality of languages, Japanese, English, and the like for example, any user can select any one of them, by pre-setting of a class selector. And this selection can be made also alter depending on the situation.

According to the other aspect of this invention, there is provided a guide system, which gives a voiced guide for each one of a plurality of guide objects by the use of any one of the above-mentioned portable type voice reproducers, provides control signal transmitters. Each of the transmitters is arranged to the guide object corresponding thereto and transmits a control signal continuously at least during necessary of the guide or during the open time of exhibition of the objects. The above-mentioned portable type voice reproducer comprises a control signal detector to receive and detect any one of the control signals transmitted by the control signal transmitters, and reproduces and outputs a voice-guide data as a voiced message corresponding to the guide object.

It is preferable that the above control signal transmitter transmits the control signal from an antenna by a weak power radio signal or directly by a light signal, and the portable type voice reproducer to be positioned corresponding thereto receives the control signal by wireless.

### BRIEF DESCRIPTION OF THE DRAWINGS

FIG. 1 shows an example of a conventional portable type voice reproducer and a guide system for use of the reproducer;

FIG. 2 shows another example of a conventional portable type voice reproducer and a guide system different from that shown in FIG. 1;

FIG. 3 shows a block diagram for a portable type voice reproducer and a guide system according to a first embodiment of the present invention;

FIG. 4 shows a memory data explanatory view for a voice-data memory card shown in FIG. 3;

FIG. 5 shows a block diagram for a portable type voice reproducer and a guide system according to a second embodiment of the present invention.

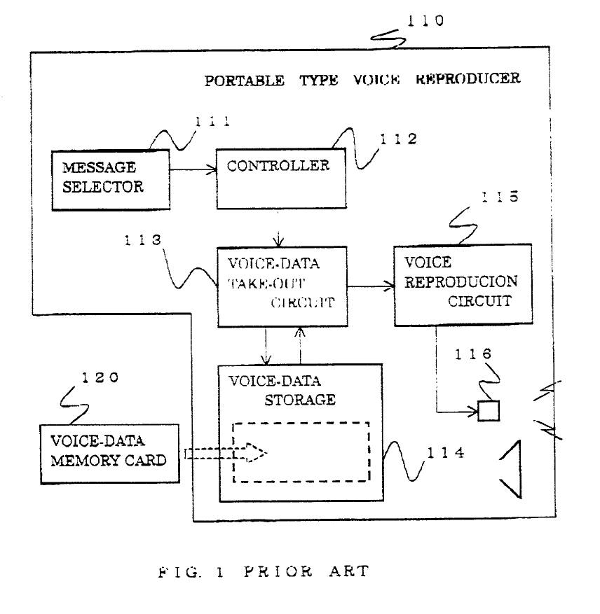

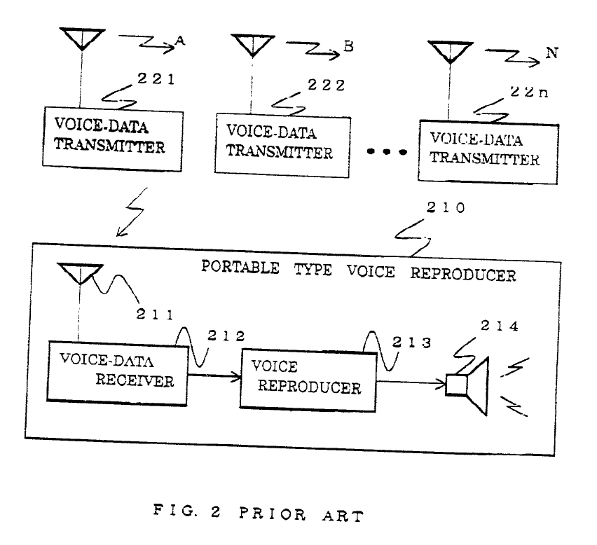

### DESCRIPTION OF THE PREFERRED EMBODIMENTS

Now, several preferred embodiments of the present invention will be described with reference to the accompanying drawings.

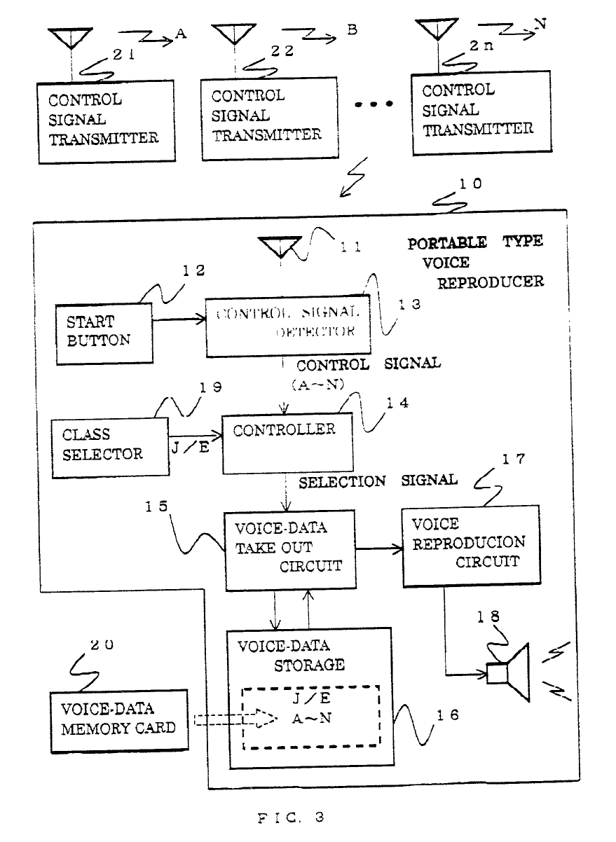

Referring to FIG. 3, a guide system according to a first embodiment of the present invention comprises a portable type voice reproducer 10, a voice-data memory card 20, and control signal transmitters 21-2n. The voice-data means voice guide data to have a plurality of kinds, each of which corresponds to a voiced message for a guide. In the guide system, a user equips the voice-data memory card 20 to the portable type voice reproducer 10. The voice-data memory card 20 is a voice-data memory medium to store a plurality of kinds of voice-guide data. The portable type voice reproducer 10 receives control signals A-N sent from the control signal transmitters 21-2n respectively and selects one of them. And then, one kind of the voice-guide data corresponding to the selected control signal and a guide object is reproduced to a voiced message as a guide. As a result, the user can hear the required guided message by voice.

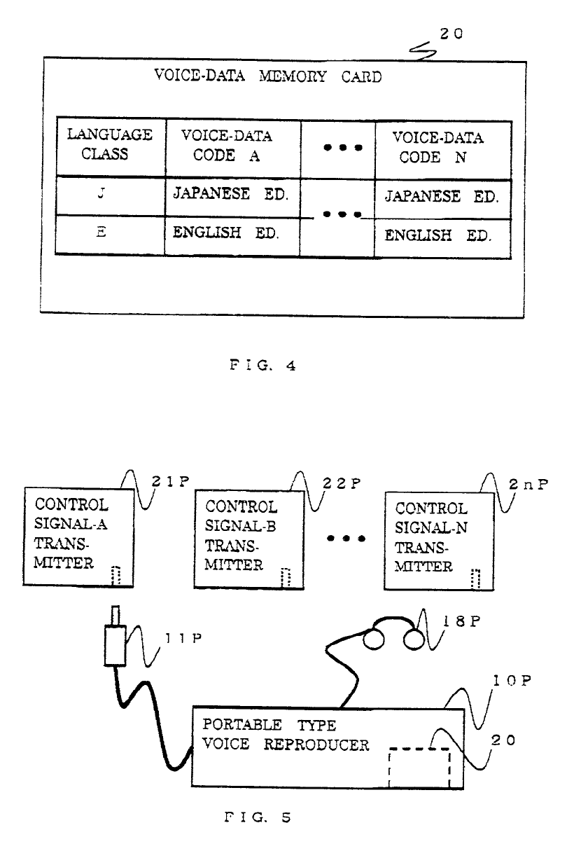

The portable type voice reproducer 10 comprises an antenna 11, a start button 12, a control signal detector 13, a controller 14, a voice-data take-out circuit 15, a voice-data storage 16, a voice reproduction circuit 17, a speaker 18, and a class selector 19. The voice-data memory card 20 having data shown in FIG. 4 is equipped by inserting and fixed into the voice-data storage 16. And the control signal transmitters 21-2n respectively have positions and output powers so as not to interfere mutually.

As shown in FIG. 4, the voice-data memory card 20 has previously recorded and stored the voice-guide data corresponding to a plurality of exhibits (A-N) to memory areas of voice-data codes A-N respectively. And each of the voice-data codes A-N has such two kinds of the voice-guide data of Japanese (J) and English (E) Editions for example each of which is discriminated by language classes J and E as the message classes. Combinations of Codes A, -N and the classes J/E are corresponding to the voiced messages, to which the user will listen by their reproduction.

Control signals A-N are also corresponding to the plurality of exhibits (A-N) respectively and can specify the voice-data codes A-N in the voice-data memory card 20 respectively. Accordingly, the control signal transmitters 21-2n transmit the control signals A-N corresponding thereto respectively.

Referring to FIG. 3 again, the portable type voice reproducer 10 will be described below.

The antenna 11 receives the control signals A-N transmitted from the control signal transmitters 21-2n each and sends out them to the control signal detector 13. The start button 12 starts works of the control signal detector 13. The control signal detector 13 is a selector of the exhibits, detects a control signal of the maximum level among the control signals A-N receiving from the control signal transmitters 21-2n each, and gives a notice of the control signal N for example to the controller 14.

The controller 14 has memorized the language class J for example, previously set from the class selector 19. Receiving the control signal N for example from the control signal detector 13, the controller 14 sends out a selection signal JN, combined the language class J and the control signal N, to the voice-data take-out circuit 15.

The voice-data take-out circuit 15 takes out one of the voice-guide data corresponding to the received selection signal JN from the voice-data storage 16 and sends out it to the voice reproduction circuit 17. The voice-data storage 16 receives the selection signal JN from the voice-data take-out circuit 15. And then the voice-data storage 16 makes a path for use of taking out the voice-guide data of Japanese Edition stored in the memory area of the language class J and the voice-data code N of the voice-data memory card 20.

The voice reproduction circuit 17 receives the voice-guide data of Japanese Edition in code N, converts and reproduces it to a audible signal of a guided message for the exhibit (N) by Japanese, and outputs it by a voice from the speaker 18.

The class selector 19 is used for selections of one of the languages, in case that the voice-data memory card 20 stores the several kinds of voice-guide data of languages of Japanese and English for example. Generally, it is preferable that the selector has switches to be capable of setting in advance at the time of rental of the portable type voice reproducer. The switches may be a structure to be capable of selection by the user.

In case that the start button is of a non-lock type, a push operation of the start button will newly reproduce and output the voiced message from the beginning, on the basis of a control signal to have been received. Accordingly, although the voiced message being reproduced until then is stopped, it is avoided to start listening to the voiced message still in progress.

While it has been described to prepare and operate the start button, in a case of preparation of an automatic starting circuit in stead of the start button. As a result, it is capable to add a function that, when the control signal detector detects a new control signal, a user can automatically listen to a new reproduced voice fully in stead of the reproduced voice still in progress as a user removes and comes near another exhibit.

While it has been described that the voice-data take-out circuit takes out only one of voice-data, it is capable to add a function to reproduce and output continuously the voice-data according to the received control signal during detection of the corresponding control signal.

In a case that the voice-data memory cards are prepared for each language, for example Japanese, English, and the other languages respectively, the language selector or it's handling is not necessary. Here, while the voice-data memory card has been described regarding a storage medium, the medium may be a memory disk or the other one.

While the speaker has been described as the voice output device, it is preferable to be an earphone or a headphone to be use individually or with turnover switch.

And each of the control signal transmitters 21-2n transmits an electric wave of a radio signal by a different frequency or combined frequencies from others with a faint level of output power. That is, the radio signal has such a faint level as the portable type voice reproducer according to this invention can receive and detect the radio signal only on the outskirts of the corresponding exhibit. And such the control signal is continuously transmitted during under open in the exhibition hall. Of course, the any type or the any system of the radio signals can be applied, but it is preferable that in the structure and the circuit the maintenance and the handling are easy, the power consumption is few, and the facilities are simple.

Subsequently, referring to FIG. 5, another embodiment of a guide system different from FIG. 3 will be described below. The embodiment shown in FIG. 5 is effective for use in a case that exhibits position adjacent mutually. Each of transmitters 21P-2nP of control signals A-N is arranged for each corresponding exhibit and has at least one of jacks in stead of an antenna shown in FIG. 3, and sends a corresponding one of the control signals A-N to the jacks.

A portable type voice reproducer 10P has a jack 11P and a headphone 18P in stead of the antenna 11 and the speaker 18 shown in FIG. 3. As the direct connection of a plug-jack system can avoid any receipt of a plurality of control signals, it is capable of sure receiving of a voiced message for the closed exhibits. Moreover, as only a user can listen to the voiced message by a headphone or an earphone, the voiced message is not an annoyance to nearby visitors.

While referring to FIG. 3 the start button connects with the control signal detector, it is capable that the control signal detector detects the control signal by receipt of the control signals from the antenna. As another manner, the start button can be connected to the controller. In this case, the controller immediately starts operation of the voice reproducer, and then the user can listen to the reproduced voice with few time lags from beginning of the voiced message.

While referring to FIG. 3 the control signal is a radio signal using of the antenna, it is capable of use of such a ray as an infrared ray for example. In this case, a transmitter can transmit a ray corresponding to a number code of a plurality of kinds from a remote control pad and a control signal detector provided in the portable type voice reproducer discriminates the ray transmitted. As a result, it is capable of realization of a cheaper voice reproducer applying prior arts and a guide system using the voice reproducer.

While referring to FIG. 4 the language class is shown as the message class, the classes can be specified by not only languages, but by the others such as exhibition halls.

While the present invention has been described in detail in conjunction with the several preferred embodiments thereof, the present invention is not limited to the foregoing description but can be modified in various manners without departing from the scope of the invention set forth in appended claims.

As apparent from the foregoing description, according to the present invention, the guide system is capable of both simplification of facilities corresponding to guide exhibits and convenience for users of the portable type voice reproducer.

What is claimed is:

1. A portable type voice reproducer, which reproduces and outputs a voiced message selected from a plurality of kinds of voice-data to be data for voiced messages, comprising:
a detection means detecting a signal received from outside corresponding to the voiced message;
a storage means storing the voice-data;
a take-out means taking out a kind of the voice-data from said voice-data storage corresponding to the signal detected by said detection means; and
a voice reproduction means converting the voice-data received from said take-out means to an audible signal of the voiced message, and reproducing and outputting the reproduced voiced message outside.

2. A portable type voice reproducer according to claim 1, further comprises a start button beginning of execution of said detection means

3. A portable type voice reproducer, which reproduces and outputs a voiced message selected from a plurality of kinds of voice-data to be data for voiced messages, comprising:
a control signal detector receiving and detecting a control signal, which is received from outside and prepared for use of selection of one kind of the voice-data corresponding to each voiced message;
a voice-data storage storing the voice-data;
a voice-data take-out circuit receiving the control signal detected by said control signal detector and taking out a kind of the voice-data corresponding to the control signal from said voice-data storage; and
a voice reproduction circuit converting the voice data received from said voice-data take-out circuit to an audible signal of the voiced message, and reproducing the voiced message; and
a voice output device outputting the voiced message reproduced by said voice reproduction circuit.

4. A portable type voice reproducer according to claim 3, further comprises a start button beginning of execution of said control signal detector.

5. A portable type voice reproducer according to claim 3, wherein said control signal is a radio signal of a faint power level, and said control signal detector receives the radio signal from outside through an antenna.

6. A portable type voice reproducer according to claim 3, wherein said control signal is a light signal, and said control signal detector receives and detects the light signal from outside.

7. A portable type voice reproducer according to claim 3, wherein said voice-data storage has equipped a voice-data memory medium, which is attachable and removable and has stored a plurality of kinds of said voice-data therein.

8. A portable type voice reproducer according to claim 3, further comprising a class selector selecting one of message classes, which are included in each of the kinds of the voice-data corresponding to each of the voiced messages.

9. A guide system, which guides each of a plurality of guide objects by a corresponding voiced message by use of a portable type voice reproducer, comprising:
signal transmitters, each of which is arranged at each of said guide objects and transmits a signal for discrimination of said corresponding guide object continuously at least during execution of the guide; and
said portable type voice reproducer, which reproduces and outputs a voiced message selected from a plurality of kinds of voice-data to be data for voiced messages respectively corresponding to the guide objects, comprising;
a detection means detecting a signal received from said signal transmitter corresponding to the voiced message;
a start button beginning execution of said detection means
a storage means storing the voice-data;
a take-out means taking out a kind of the voice-data from said voice-data storage corresponding to the signal detected by said detection means; and
a voice reproduction means converting the voice-data received from said take-out means to an audible signal of the voiced message, and reproducing and outputting the reproduced voiced message outside.

10. A guide system, which guides each of a plurality of guide objects by a corresponding voiced message by use of a portable type voice reproducer, comprising:
control signal transmitters, each of which is arranged at each of said guide objects and transmits a control signal for discrimination of said corresponding guide object continuously at least during execution of the guide; and
said portable type voice reproducer, which reproduces and outputs a voiced message selected from a plurality of kinds of voice-data to be data for voiced messages respectively corresponding to the guide objects, comprising:
a control signal detector receiving and detecting the control signal, which is received from said control signal transmitter and prepared for use of selection of one kind of the voice data corresponding to the detected one of said control signal transmitters;
a voice-data storage storing the voice-data;
a voice-data take-out circuit receiving the control signal detected by said control signal detector and taking out a kind of the voice-data corresponding to the control signal from said voice-data storage;
a voice reproduction circuit converting the voice-data received from said voice-data take-out circuit to an audible signal of the voiced message, and reproducing the voiced message; and
a voice output device outputting the voiced message reproduced by said voice reproduction circuit.

11. A guide system according to claim 10, wherein said control signal is a radio signal of a faint power level, and said control signal detector receives the radio signals from said control signal transmitters through an antenna.

12. A guide system according to claim 10, wherein said control signal is a light signal, and said control signal detector receives and detects the light signals from outside said control signal transmitters.

13. A guide system according to claim 10, wherein said portable type voice reproducer further comprises a start button beginning of execution of said control signal detector.

14. A guide system according to claim 10, wherein said voice-data storage has equipped a voice-data memory medium, which is attachable and removable and has stored a plurality of kinds of said voice-data therein.

15. A guide system according to claim 10, further comprising a class selector selecting one of message classes, which are included in each of the kinds of the voice-data corresponding to each of the voiced messages.
